(19) United States
(12) Patent Application Publication
(10) Pub. No.: US 2006/0226808 A1
(43) Pub. Date: Oct. 12, 2006

(54) Charger with replaceable plugs

(76) Inventor: K.Y. Hung, Kowloon (CN)

Correspondence Address: BIRCH STEWART KOLASCH & BIRCH, PO BOX 747, FALLS CHURCH, VA, 22040-0747, US

(21) Appl. No.: 11/101,557

(22) Filed: Apr. 8, 2005

(51) Int. Cl. H02J 7/02

(52) U.S. Cl. 320/111

(57) ABSTRACT

A charger (10) with replaceable plugs of the present invention includes a back cover (30) having a slide groove (32) set on the lower wall, two holes (34) are excavated at the undersurface of the slide groove and, a “Z” shaped key being provided on the groove. The plug portion (40) of the charger has a base (411), a clasp (414) is installed on the bottom of the top portion to engage with the secure fastener on the back cover. The charger further includes an elastic tab (60) to joint the PCB board (50) with all kinds of plugs thus conduct the power supply. The plug is not easily fall off due to the design of the clasp is mounted into the secure fastener. The structure of the charger is simple, the charger is easy for plug in and safety in using, and the cost is lower.

### BACKGROUND OF THE INVENTION

1. Field of the Invention

The present invention relates to charger, and more particularly to charger with replaceable plugs for matching different specification of electrical sockets.

2. Description of Prior Art

Portable diminutive chargers are widely used nowadays, some of them are used for power supply, some for charging device. Although common chargers can meet basic requirements in daily life, they are restricted by their configuration and inconvenient in some situations. Most chargers having the plugs fixed on the body so people have to bring various kinds of chargers to match different kind of electric sockets when traveling or going abroad. Moreover, even the charger with replaceable plugs has already available in commerce, it has some defects in design, such as in safety and in the structure of its interface, most of the shortcomings are: the plug is so flexible that easy to fall off, unsafe, and, the structure is so complex that makes the high cost.

An improved charger with replaceable plugs which overcomes the above-described problems is desired.

### SUMMARY OF THE INVENTION

Accordingly, an object of the present invention is to provide a multifunctional charger with replaceable plugs to match with different kind of electric sockets. The plug is firmly fixed on the charger, the structure is simple, and the charger is safety in using, lasting longer, lower in cost.

In order to achieve the object set forth, a preferred charger with replaceable plugs according to the invention comprises a front cover, a back cover, a plug portion and a PCB (printed circuit board). The front cover is engaged with the back cover, the plug portion is set on the back cover movably, the PCB is fixed at the place where the front cover engaged with the back cover. A slide groove is set on the bottom of the back cover, two holes are set on the lower portion of the slide groove. A “Z” shaped key is fixed on the slide groove, a keystroke is set on one side of the “Z” shaped key and a secure fastener is set on the other side, the keystroke is set on the lower side of the slide groove and the secure fastener is extending upward along the side wall from the lower side of the slide groove. The plug portion comprises a base portion, the base portion defines a base wherein a top portion extending from the side wall of said base, a clasp is set on the bottom of the top portion to engage with the secure fastener on the back cover. The charger further comprises an elastic tab, the elastic tab defines a body, a first bent arm and a second bent arm, a first bent portion of the first bent arm is deposited into the hole on the slide groove.

Other objects, advantages and novel features of the invention will become more apparent from the following detailed description when taken in conjunction with the accompanying drawings, in which:

### BRIEF DESCRIPTION OF THE DRAWINGS

FIG. 1 is a structural schematic of a charger with replaceable plugs of the present invention;

FIG. 2 is an exploded view of a charger with replaceable plugs of the present invention;

FIG. 3 is another exploded view of a charger with replaceable plugs of the present invention;

FIG. 4 is a structural schematic of an elastic tab of a charger with replaceable plugs of the present invention;

FIG. 5 is a cross-sectional view of a charger with replaceable plugs of the present invention;

FIG. 6 is a cross-sectional view of the working status of a “Z” shaped key in a charger with replaceable plugs of the present invention.

### DETAILED DESCRIPTION OF THE INVENTION

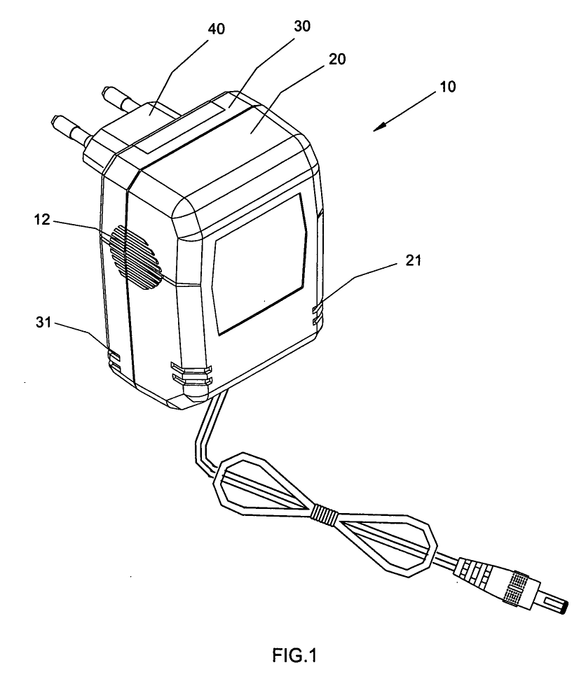

Referring to FIG. 1, a preferred embodiment of the charger with replaceable plugs of the present invention includes a charger 10, the charger 10 includes a front cover 20, a back cover 30 and a plug portion 40. The front cover 20 is engaged with the back cover 30, the plug portion 40 is set on the back cover 30 movably. The ridges where the outer surfaces of the front cover 20 and the back cover 30 intersecting are transited by a tangential angle. Four windows 21, 31 for emitting heat are symmetrically set on the surfaces of the front cover 20 and back cover 30 separately, two of them arranged on each side paratactically to accelerate the emanation of heat from the charger 10; also, a plurality of wales 12 are set on the side wall of the front cover 20 and the back cover 30 to decorate and help the user to hold.

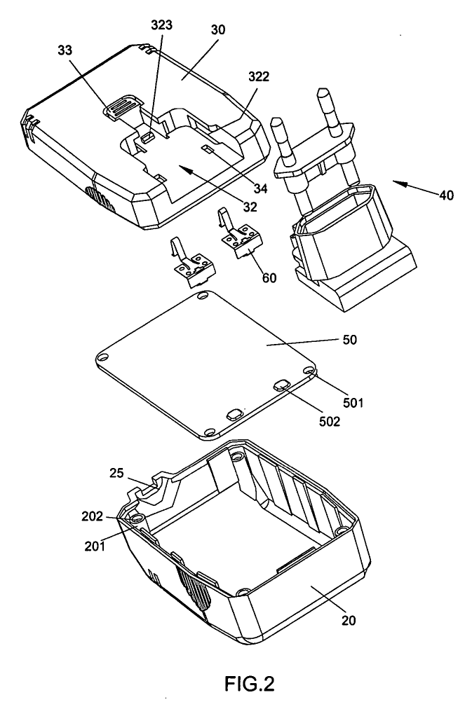

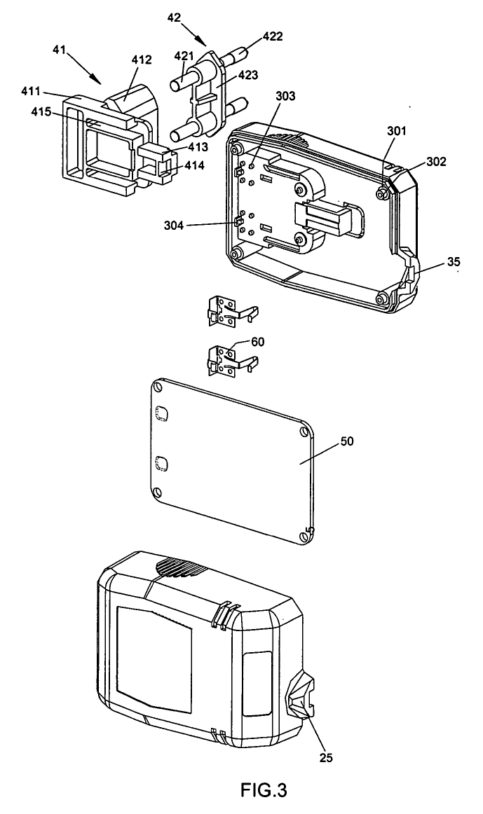

Referring to FIG. 2 and FIG. 3, the charger 10 of the present invention further includes a PCB 50, the PCB 50 is fixed at the place where the front cover 20 is engaged with the back cover 30. Four holes 501 for assemble are defined at each corner of the PCB 50 and two protrudes 502 are set on the fringe of one side of the PCB 50.

The front cover 20 defines a space inside, four columns 201 are fixed separately on the four ridges at the inner side of the front cover 20, each column 201 defines an end on the top to form a sidestep 202 therein; a curved fastener 25 is provided on one side wall of the front cover 20 and extending outside to contain the connector and lines which connecting with the PCB 50.

A sunken slide groove 32 is provided on the bottom of the back cover 30, two holes 34 are set on the lower portion of the slide groove 32, slots 322 are deposited separately on the side wall of the slide groove 32. The bottom of the groove 32 is extending to form a narrow portion, a “Z” shaped key is set on the narrow portion by moulding injection with the back cover 30, a keystroke 33 is defined on the first end of the “Z” shaped key and a secure fastener 323 is defined on the second end, where the key 33 is deposited on the bottom of the narrow portion and, the secure fastener 323 is extending upward from the bottom of the slide groove 32. Further, the “Z” shaped key has the characteristic of good elasticity. Two groups of plastic rods 303 are set on another undersurface which relative to the slide groove 32 inside the back cover 30, each group defines four rods. Two rectangular pillars 304 are set on the inner wall of the back cover 30; the position of the two rectangular pillars is corresponding to the position of the two holes 34. Back cover 30 being provided with columns 201 at the inner side of its four ridges, each column 301 defines an end 302 on the top, the diameter of the end 302 is suited with the diameter of the holes 501 on the PCB 50, and the end 302 can be deposited into the columns 201 on the front cover 20, the top portion of the end 302 is inosculate with the sidestep 202; a curved fastener 35 is provided on one side wall of the back cover 30 and inosculate with the fastener 25.

Plug portion 40 includes a base portion 41 and a conduction leg portion 42, wherein the base portion 41 includes a base 411 and a containing portion 412 setting onside the base 411. The containing portion 412 is an oblate cylinder with an opening on top end and a part-opening on nether end; a top portion 413 is extending from the side wall of the base 411 and, a clasp 414 is set on the bottom of the top portion 413 to mount into the secure fastener 323 of the back cover 30. In addition, two elongated slots 415 are set at the lower portion of the base 411, the space between the two elongated slots 415 is corresponding to the space between the two holes 34 on the slide groove 32. The conduction leg portion 42 defines a sidestep 423 thereon, a first conduction leg 421 and a second conduction leg 422 extending outwards respectively from each side of the sidestep 423, the first conduction leg 421 is deposited inside the containing portion 412 and, the sidestep 423 is full engaged with the containing portion 412.

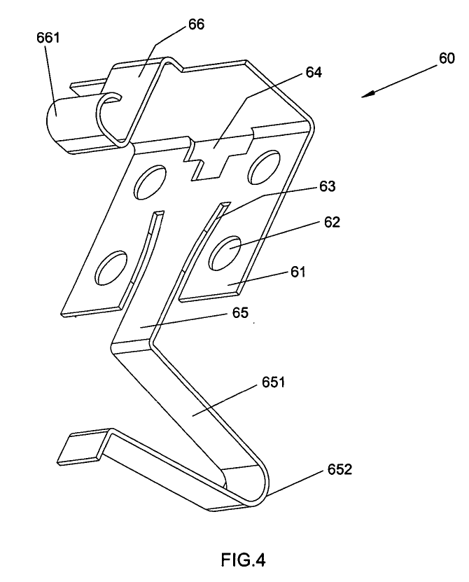

Referring to FIG. 4, the charger further includes an elastic tab 60 with a body 61, four circular holes 62 separately set on four corners of the body 61 and oppositely arranged to the plastic rods 303 on the slide groove 32. At the inner side of the two circular holes 62 on one side of the body 61, two elongated apertures 63 are excavated to form an elastic board 65 on the body 61, the elastic board 65 extending outward and turn to plumb with the elastic board 65, then turn back to form a first bent arm 651; simultaneously, a first bent portion 652 of the first bent arm 651 is deposited into the hole 34 to contact with the first conduction leg 421 on the conduction leg portion 42. A second bent arm 66 is extending from the body 61 to the opposite direction relative to the first bent arm 651, a second bent portion 661 on the second bent arm 66 is contacting with the protrudes 502 on the PCB 50 to transmit electric current. An opening for engagement 64 is located at the cross spot of the body 61 and the second bent arm to engage with the rectangular pillars 403 in the back cover 30. This kind of design makes the elastic tab joint the plug with the PCB to conduct with the power supply. The contacts of the elastic tab with the PCB 50 and the first conduction leg 421 are point contacts other than surface contacts, which make higher reliability, and overcome the defect of losing contact due to long time using. The elongated apertures 63 on the body 61 makes the elastic tab have more elastic deformation ability after been assembled, and therefore with longer life.

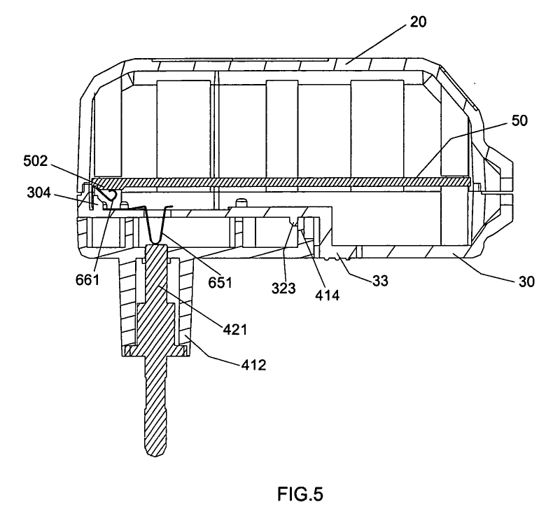

Referring to FIG. 5, in assembling, the first bent portions 652 of the two elastic tabs 60 is traversed through the two holes 34 of the back cover 30, then the plastic rods 303 is installed into the circular holes 62 of the elastic tab 60 and the plastic rods 303 is welded therewith; so the elastic tab 60 is impacted. Then the PCB 50 is installed onto the back cover 30 to make the four holes 501 engaged with the top end 302 of the columns 301 separately, thus the second bent portion 661 is contacted with the protrudes 502. And then, the columns 201 are engaged on the front cover 20 with the columns 301 of the back cover 30, the front cover 20 and the back cover 30 are tightly jointed by the way of ultrasonic welding. When the plug portion 40 is assembled, the first conduction leg 421 is installed into the elongated slots 415 by passing it through the containing portion 412 on the base portion 41, and the lower end of the first conduction leg 421 is on the same level with the undersurface of the base 411, then the sidestep 423 is engaged with the upper side of the containing portion 412, and then the base 411 is covered alongside the slide groove 32 till the clasp 414 is mounting into the secure fastener 323, therefore, the lower end of the first conduction leg 421 is contacted with the first bent portion 652 of the first bent arm 651. Thus, the assembling of the charger with replaceable plugs is accomplished. Due to the design of the clasp 414 is mounted into the secure fastener, the plug is uneasy to fall off and safe in using.

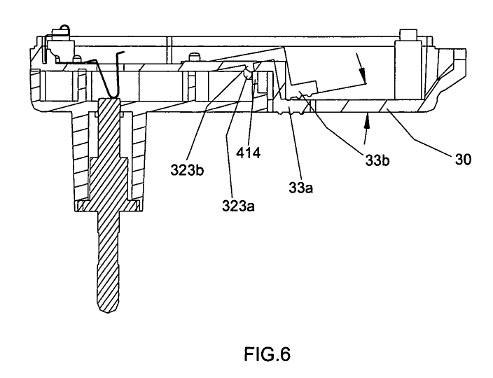

With reference to FIG. 6, when plug portion 40 is deposited into the slide groove 32, the secure fastener 323a on the “Z” shaped key is engaged with clasp 414, and the keystroke 33a is on the same level with the surface of the back cover 30. When pressing keystroke 33a to the position of keystroke 33b, the connected secure fastener 323a is moving down to the position of secure fastener 323b, and secure fastener 323b separating from the clasp 414, thus the plug portion 40 can be taken off.

The charger of the present invention is suitable for all kinds of plugs, such as plugs under the criterion of UL, 3C, BS, SAA and VDE.

In summary, the advantages of the charger with replaceable plugs of the present invention is that the plug be firmly fixed by the design of the clasp is mounted into the secure fastener, the charger is safety in using, long lasting, lower in cost and the structure is simple.

Although the present invention has been described with specific terms, it should be noted that the described embodiment is not necessarily exclusive, and that various changes and modifications may be made thereto without departing from the scope of the present invention as defined in the appended claims.

I claim:

1. A charger with replaceable plugs, comprising:
a front cover;
a back cover;
a plurality of plugs; and
a PCB (printed circuit board); wherein
said back cover is engaged with the front cover, one of the plurality of plugs is installed on the back cover moveably and, the PCB is installed on the place where the front cover and back cover is engaged, said back cover defines a slide groove on the lower wall thereof, two holes are defined at the undersurface of the slide groove, said slide groove also being provided with a “Z” shaped key, wherein a keystoke is set on the first end of said “Z” shaped key and a secure fastener is set on the second end of said “Z” shaped key, said keystoke is set on the lower side of said slide groove and said secure fastener is extending upward from the lower side of said slide groove; said plug comprises a base portion, the base portion defines a base thereof, wherein a top portion is extending from the side wall of said base, a clasp is set on the bottom of said top portion to mount into the secure fastener on said back cover; said charger further comprises an elastic tab, the elastic tab defines a body thereon, a first bent arm and a second bent arm, a first bent portion of said first bent arm is deposited into said hole.

2. A charger with replaceable plugs as described in claim 1, wherein said body of the elastic tab defines a elastic board thereon, said elastic board extends outward then turn to form the first bent arm, said second bent arm extends from the body to the opposite direction relative to the first bent arm; two elongated apertures are excavated on the body.

3. A charger with replaceable plugs as described in claim 1, wherein two groups of plastic rods are set on another undersurface corresponding to the slide groove inside said back cover.

4. A charger with replaceable plugs as described in claim 3, wherein the body of said elastic tab further defines a group of circular holes thereon, said circular holes are arranged opposite to said plastic rods.

5. A charger with replaceable plugs as described in claim 1, wherein two rectangular pillars are defined in the inner wall of said back cover, and the position of the rectangular pillars is corresponding to the position of said two holes.

6. A charger with replaceable plugs as described in claim 5, wherein an opening for engagement is located at the cross spot of said body and said second bent arm whereby to engage with said rectangular pillars.

7. A charger with replaceable plugs as described in claim 1, wherein said plug further comprises a conduction leg portion having a sidestep, a first conduction leg and a second conduction leg extending respectively to each side of said sidestep; said base portion has a base and a containing portion set onside the base, said first conduction leg is deposited inside said containing portion.

8. A charger with replaceable plugs as described in claim 1, wherein two elongated slots are set at the lower portion of said base, and the space between said two elongated slots is correspond to the space between said two holes on said slide groove.

9. A charger with replaceable plugs as described in claim 1, wherein said front cover being provided with columns at the inner side of its four ridges, each column has an opening on the top, and a sidestep is deposited into said opening.

10. A charger with replaceable plugs as described in claim 1, wherein said back cover being provided with columns at the inner side of its four ridges, each column has an end on the top, said end is deposited into said column, and the top portion of said end is contacted with said sidestep.

11. A charger with replaceable plugs as described in claim 1, wherein said “Z” shaped key is injection moulding with said back cover.
